(19) United States
(12) Patent Application Publication
(10) Pub. No.: US 2026/0329569 A1
(43) Pub. Date: Oct. 22, 2026

(54) ONBOARDING OPERATING SYSTEM (OOS) UPGRADE DURING DEVICE ONBOARDING

(71) Applicant: Dell Products L.P., Round Rock, TX (US)

(72) Inventors: Mahesh Babu Ramaiah, Bangalore (IN); Nyi Nyi Thwin, Singapore (SG); Xingyu Wang, Singapore (SG)

(73) Assignee: Dell Products L.P., Round Rock, TX (US)

(21) Appl. No.: 19/180,642

(22) Filed: Apr. 16, 2025

(51) Int. Cl. G06F 8/65; G06F 9/4401

(52) U.S. Cl. CPC G06F 8/65; G06F 9/4401

(57) ABSTRACT

A method and system for upgrading an onboarding operating system (OOS) during device onboarding is disclosed. The OOS is updated during onboarding to mitigate vulnerabilities and compatibility issues that arise from outdated systems. An example solution involves using the Fast Identification (ID) Online (FIDO) Device Onboarding (FDO). A device establishes a secure communication channel with a control plane, identifies the current OOS, receives an updated OOS, and reboots using the updated OOS from a temporary partition. This method can also update firmware and other components, thereby enhancing security and functionality.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment. An entity can acquire new computing devices for its use, and configure them to be used in its network of devices. There can be protocols to onboard computing devices to a particular entity's device management system. A device management system can be configured to manage the devices in an entity's network of devices.

### SUMMARY

Embodiments are directed to a mechanism to reinstate a secure onboarding OS through optimized onboarding using the Fast Identification (ID) Online (FIDO) Device Onboarding (FDO) protocol. This method decouples the OOS release schedule and the production schedule so that the OOS version installed on a device can be upgraded when the device is onboarded. This method eliminates the need for backward compatibility support on Control Plane for modules other than FDO. In addition to upgrading device OOS, this method can also be used to upgrade other components such as firmware during onboarding. The ability to upgrade OOS when new vulnerabilities are found shrinks the attack surface of the OOS to only the first part of FDO.

In one embodiment, a device comprises a processor and a memory storing program instructions. When executed, the program instructions configure the device to establish a secure communication channel to a control plane during an onboarding process, identify a current onboarding operating system, receive a new operating system from the control plane, set a next boot instruction to use the new operating system, and reboot the device accordingly. In some embodiments, the device creates a temporary partition on a hard drive, installs the new operating system onto that partition, and designates the partition for the next boot. Following the reboot, the device may determine that the boot was completed using the new operating system from the temporary partition, replace the current operating system with the new one, adjust the boot order, and remove the temporary partition. In other embodiments, the device fails the onboarding process upon receipt of the new operating system. The device may also update a firmware version by identifying a current firmware version, receiving new firmware from the control plane, and installing the new firmware prior to rebooting. In still other embodiments, the onboarding process employs a Fast Identification (ID) Online Device Onboarding protocol with specific messages used to identify the current operating system and to receive the new operating system.

In another embodiment, the disclosure provides a method for upgrading an onboarding operating system on an edge computing device. The method includes preparing the device to execute an onboarding protocol, establishing a secure communication channel with a control plane, and identifying the current onboarding operating system to that control plane. The method further comprises determining whether an updated operating system is available, receiving the updated operating system from the control plane, and rebooting the device into the updated operating system. In some implementations, the method further includes creating a temporary partition on a hard drive, installing the updated operating system onto this temporary partition, and setting the device to boot from the temporary partition on a subsequent reboot. The method may also involve determining whether the device successfully booted from the temporary partition and, if so, replacing the current operating system with the updated one and removing the temporary partition; alternatively, if the device did not boot from the temporary partition, the onboarding protocol may be reinitiated. Additionally, the method can include failing the onboarding protocol upon receipt of the updated operating system, and may further involve updating a firmware version by identifying a current firmware version, receiving new firmware from the control plane, and installing the new firmware prior to rebooting. The method employs a Fast Identification (ID) Online Device Onboarding protocol that uses designated messages to exchange operating system information.

These and other features of the disclosure will be more clearly understood from the following detailed description and accompanying drawings.

### BRIEF DESCRIPTION OF THE DRAWINGS

Having thus described the invention in general terms, reference will now be made to the accompanying drawings, which are not necessarily drawn to scale, and wherein:

FIG. 1 is a flowchart illustrating a typical process for device onboarding.

FIGS. 2A and 2B show a flowchart illustrating a process for updating the OOS during device onboarding.

FIG. 3 is a sequence chart illustrating communications between a device and a Control Plane to update the device's OOS.

FIG. 4 shows an example of an Information Handling System (IHS) configured to implement systems and methods as described herein for updating the OOS for devices during FDO.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The embodiments disclosed herein can generally be implemented as part of device onboarding protocols, such as a Fast Identification (ID) Online (FIDO) Device Onboarding (FDO) protocol. However, it will be appreciated that the present techniques can also be applied to a variety of protocols. FDO is generally designed to be a zero-touch onboarding solution that streamlines a supply chain from a manufacturer/factory to a cloud service provider or a device management platform. FOD provides auto-provisioning at a target destination via late binding. FDO can use public key management technology to provide verifiable security protection through the supply chain.

Using FDO, manufacturers build a device and also generate a digital owner voucher that does not need to be shipped with the device. The device and the ownership voucher are cryptographically linked together using public key technology. In some examples, a private key, which can be generated on the device, never leaves the device. In some examples, the private key can be generated and stored in a Trusted Platform Module (TPM) chip soldered on the motherboard of the device. A public certificate for the public key, according to an International Telecommunication Union X.509 standard, can be signed by a trusted certificate authority. This certificate can be stored in the ownership voucher.

When users, such as cloud service providers or device management service providers, order a device, the user receives an ownership voucher that contains a public key signed by seller. The ownership voucher can be used to prove the user's ownership of the device. The device can then be delivered to the owner/user, such as a cloud service provider. The owner registers an onboarding service and other information for the device in a rendezvous computer networking service, which can be used by devices to find each other and may generally be called a device discovery service. When the device is powered on and plugged into the user's network, the device will try to connect to the device discovery service using an Internet Protocol (IP) address that is preconfigured in the device.

Once connected to the device discovery service (e.g., rendezvous server), the device can retrieve the ownership voucher and verify the certificate in the ownership voucher. Using information provided by the user along with the ownership voucher in the device discovery service, the device will initiate an onboarding protocol with the user. The user can verify whether the device has the matching private key, and the device can verify whether the user has the matching signer key of the ownership voucher. If both validations are successful, the user can establish a trust relationship with the device and start device management.

In an example use case, a distributor places an order for the device. The manufacturer creates an ownership voucher with a first entry in a certificate chain. The first entry contains the device information, device discovery service information (e.g., a rendezvous service), and the distributor's public hey, which can be signed with the manufacturer's private key. When a reseller orders the device from the distributor, the distributor add a second entry into the ownership voucher certificate chain. The second entry contains device information and the reseller's public key, which can be signed by the distributor's private key. When a user orders the device from the reseller, the reseller adds a third entry to the ownership voucher certificate chain. The third entry can contain the device information and the user's public key, which is signed with the reseller's private key.

The owner of the device (i.e., the entity with the public key in the last entry of the certificate chain) can prove the ownership by validating the public key against that entity's private key. FDO protocols use this mechanism to validate the ownership. This design achieves the goal of transferring device ownership along the supply chain and supporting ownership validation across multiple owners.

An FDO architecture can define a device discovery service that is known to both the device and the ownership voucher. Device discovery service information can be described in a device credential in a device and in an ownership voucher header. A device discovery service manages ownership vouchers and enforces access control. The device discovery service can function as an authoritative source of truth of ownership vouchers. A manufacturer can associate with one or more device discovery services and delegate to these services an authority to manage the manufacturer's ownership vouchers until an FDO process for a device completes. An FDO process can implement three Transfer Ownership (TO) protocols—TO0, TO1, and TO, which focus on device onboarding.

In the factory, as part of device initialization, which creates the device credentials, the manufacturer installs an Onboarding Operating System (OOS) that will be used for onboarding when device arrives at the end customer's site. In some cases, when the devices are shipped out of the factory they can remain shut down for an extended period of time (e.g., months/years before first boot), such as sitting in the distributor's inventory, before being shipped to an end customer. When the device is eventually delivered to the end customer's site, the device boots up to the OOS and starts FDO and other onboarding procedures. However, after sitting on the shelf for a long time, the OOS in the device may already be outdated by the time the device reaches the end customer. For example, the original OOS may have vulnerabilities identified after manufacture that prompt security issues for the device.

After FDO, the device may run other modules to work with the Control Plane for other necessary onboarding procedures such as device validation and installing a post-onboarding OS (e.g., a Day-2 OS). If those modules are outdated, the Control Plane needs to be backward compatible to support the device.

The OOS release schedule needs to be closely synchronized with the device production schedule because modules, such as the device validation module, may have close dependencies on the firmware version in production. Embodiments disclosed herein provide a method to upgrade the device OOS during onboarding (i.e., first boot up) to eliminate or relieve the issues, such as vulnerability, compatibility, and security issues.

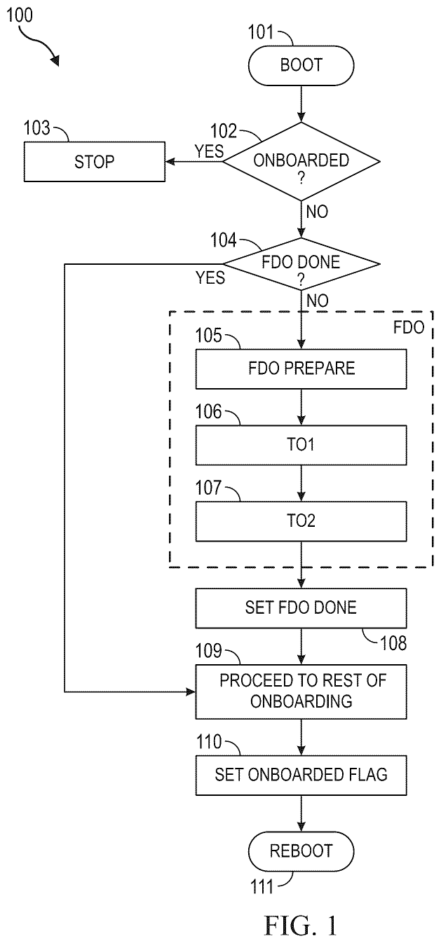

FIG. 1 is a flowchart illustrating a typical process 100 for device onboarding. At step 101, the device boots into the OOS. At step 102, the device checks whether it has been fully onboarded or has gone through FDO successfully before. If already onboarded, the process stops at 103. If not yet onboarded, the process proceeds to 104 and the device determines whether the FDO process has been completed. If FDO is complete, then the process moves to step 109 and the device proceeds with the rest of the onboarding.

If FDO is not complete at step 104, then the device begins the necessary preparations at step 105. The TO1 protocol runs at step 106, where it contacts the rendezvous server for redirection to the end Control Plane. Once redirected, the TO2 protocol runs at step 107. In the TO2 protocol, the device and Control Plane verify each other based on the device credentials in the device, which were created during manufacturing, and the ownership voucher in the Control Plane. Then, the device requests additional onboarding information from the Control Plane.

After FDO is finished, an FDO done flag is set in the device at step 108 to prevent redoing FDO if the device fails in the following onboarding steps. At step 109, the device proceeds to the rest of onboarding procedures, which includes steps such as installing a post-onboarding OS and setting the boot sequence to point to the new OS. After all the onboarding steps are complete, the device sets the Onboarded Flag at step 110, which prevents the device from redoing onboarding if the device accidentally boots back to the OOS. Then, at step 111, the device reboots to the new OS for post-onboarding operations.

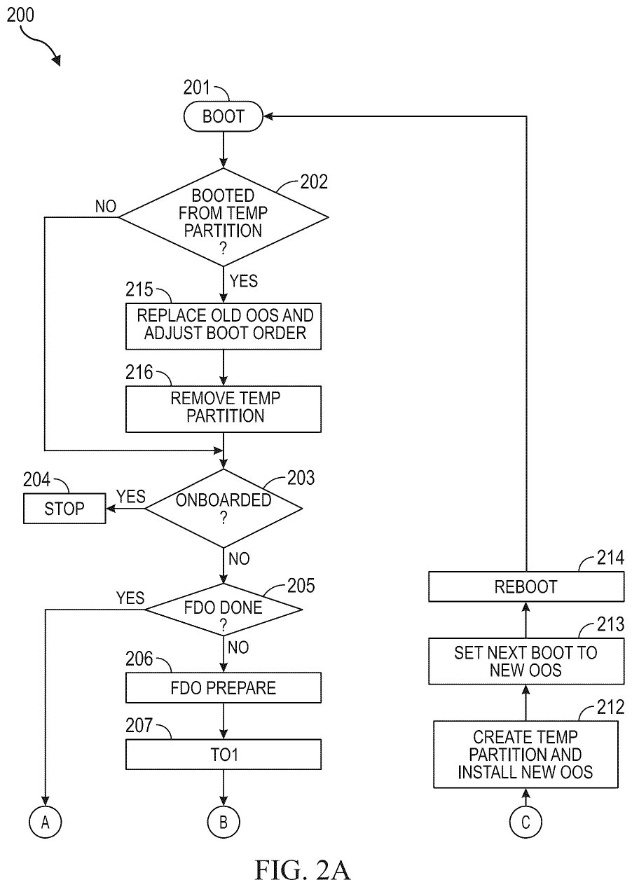

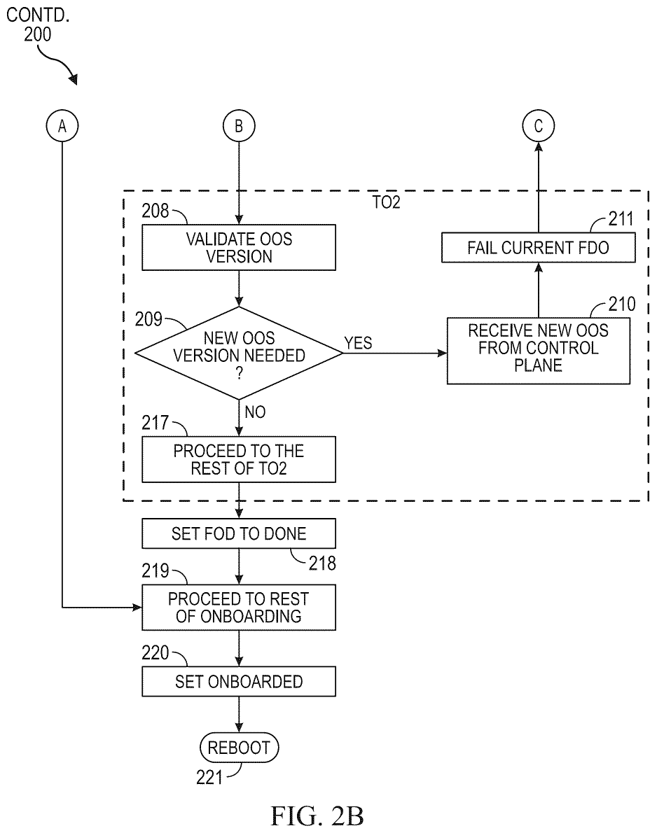

FIGS. 2A and 2B show a flowchart illustrating a process 200 for updating the OOS during device onboarding. At step 201, the device boots into the OOS. At step 202, the device checks whether it has booted from a temporary partition. If the boot is not from a temporary partition, then the process proceeds to step 203, where the initial actions are the same as shown in FIG. 1. At step 203, the device checks whether it has been fully onboarded or has gone through FDO successfully before. If already onboarded, the process stops at 204. If not yet onboarded, the process proceeds to 205 and the device determines whether the FDO process has been completed. If FDO is complete, then the process moves to step 219 and the device proceeds with the rest of the onboarding.

If FDO is not complete at step 205, then the device begins the necessary FDO preparations at step 206. The TO1 protocol runs at step 207, where the device contacts the rendezvous server for redirection to the end Control Plane. Once redirected, the TO2 protocol begins. Going into TO2, the device and the Control Plane verify each other. In step 208, the device sends the current OOS version to the Control Plane. In step 209, the Control Plane checks whether the current OOS version meets its requirements and if a new version of the OOS has been received at the Control Plane.

If the device's OOS version is out of date or otherwise does not meet the Control Plane's requirements, then the Control Plane replies with a new OOS version that it requires. In step 210, if the Control Plane replies with a new OOS version, the device requests the Control Plane to transfer the new OOS image. At step 211, once the new OOS image is fully received, the device intentionally fails the current FDO.

At step 212, the device creates a temporary partition on the device hard drive and installs the new OOS image in the partition. At step 213, the device sets the next boot to boot from the new OOS (i.e., from the partition) and initiates a reboot at step 214. This boot order adjustment is temporary. If booting to the new OOS were to fail due to either bootloader failure or new OOS image corruption, the device will fall back to boot from the original OOS and restart from step 201. That is, the original OOS is not directly replaced, which leaves room for error so that the original OOS can be used again if needed.

When the device reboots at step 201, the device again checks at step 202 whether it was booted from a partition. Because the partition was created and the reboot was redirected to the new OOS in the partition at steps 212-214, the process will move to step 215. After successful rebooting to the new OOS, the device saves the new OOS in the original OOS partition and resets the boot order (i.e., undoes step 213). In step 216, the device removes the temporary partition for the new OOS.

The process 200 then proceeds to the rest of onboarding and FDO procedures at steps 203-209. This time, at step 209, the Control Plane verifies that the device has the new OOS version and replies with OS version verification successful. Since the device's OOS version meets the Control Plane's requirements, the process moves to step 217 and the device finishes the TO2 protocol.

At step 218, after FDO is finished, the device sets FDO Done flag similar to step 108 in the original procedure to prevent redoing FDO if the device fails in the following onboarding steps. At step 219, the device proceeds to the rest of onboarding procedures, which includes steps such as component validation, installing a post-onboarding OS, and setting the boot sequence to point to the new OS. After all the onboarding steps are complete, the device sets the Onboarded Flag at step 220, which prevents the device from redoing onboarding if the device accidentally boots back to the OOS. Then, at step 221, the device reboots to the new OS for post-onboarding operations.

As noted in FIG. 2, the determination whether a new OOS is required and updating the new OOS is accomplished during the TO2 portion of FDO. In one configuration, this may be performed during the steps of TO2.NextDeviceServiceInfo and TO2.NextOwnerServiceInfo to transfer the newer version of OOS to the device, which allows the device to upgrade OOS before redoing FDO.

In some configurations, a current firmware version on the device may also be validated and updated, if needed. For example, in step 208 when the current OOS version is validated, the device's firmware version may also be sent to the Control Plane for validation. If the device requires an update, then a new firmware version may be provided with (or instead of) the new OOS in step 210. The new firmware would be installed and used after the device reboots.

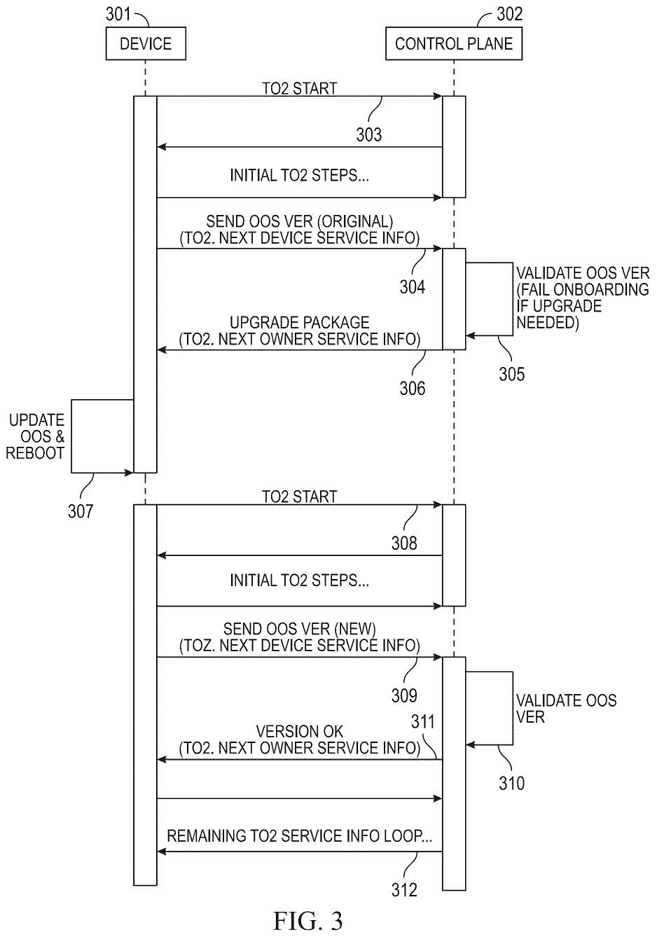

FIG. 3 is a sequence chart illustrating communications between a device 301 and a Control Plane 302 to update the device's OOS. The device 301 may be an Edge Compute Endpoint (ECE) being deployed by a new owner, for example, and the Control Plane may be an owner service. During FDO, device 301 initiates the TO2 protocol 303 with the Control Plane 302. After establishing a secure channel, the device 301 sends an OOS verification message 304. This may be sent using the TO2.NextDeviceServiceInfo message, for example. The Control Plane 302 then validates 305 the OOS version received from the device 301. If an OOS upgrade is needed, then the Control Plane 302 will fail the current onboarding process. The Control Plane 302 will then send an OOS upgrade package 306. This package may be sent as part of a TO2.NextOwnerServiceInfo message, for example. Upon receiving the new OOS, the device 301 will update the OOS as described above and will reboot 307.

After rebooting, device 301 again initiates the TO2 protocol 308 with the Control Plane 302. The device 301 then sends a new OOS verification message 309, using the TO2.NextDeviceServiceInfo message. The Control Plane 302 then validates 310 the OOS version received from the device 301. Since the new OOS has been used in the reboot on device 301, the Control Plane 302 will validate the OOS version. The Control Plane 302 sends an OOS version approved message 311 as part of a TO2.NextOwnerServiceInfo message. Upon receiving the new OOS, the device 301 will update the OOS as described above and will reboot 307. The device 301 and Control Plane 302 then complete the TO2 protocol using the new OOS version on the device 301.

In one arrangement, the Control Plane is capable of executing the FDO process disclosed herein for updating a device OOS and is also backward compatible with the legacy FDO process.

As noted above, the firmware in the system may need to be upgraded to support the new OOS. When the Control Plan transfers the OOS to the device, it can also transfer the new firmware together with OOS. Then, after the device reboots, the device will install the new firmware before booting to the new OOS.

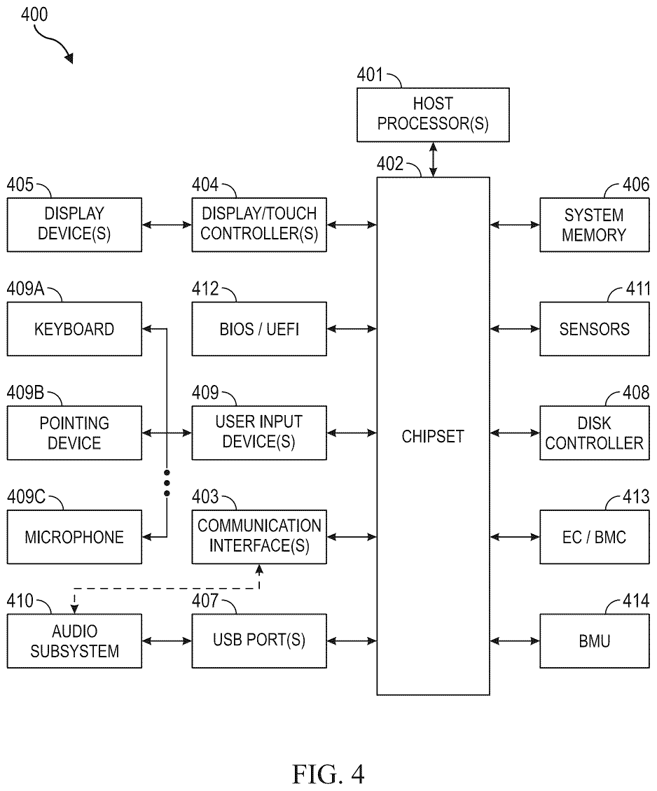

FIG. 4 shows an example of an Information Handling System (IHS) 400 configured to implement systems and methods as described herein for updating the OOS for devices during FDO. IHS 400 may be used as an edge device 301 or may host a Control Plane in various embodiments. As depicted, IHS 400 includes host processor(s) 401. IHS 400 may be a single-processor system or a multi-processor system including two or more processors. Host processor(s) 401 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 400 includes chipset 402 coupled to host processor(s) 401. Chipset 402 may provide host processor(s) 401 with access to resources. In some cases, chipset 402 may utilize a QuickPath Interconnect (QPI) bus to communicate with host processor(s) 401. Chipset 402 may also be coupled to communication interface(s) 403 to enable communications between IHS 400 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 403 may be used to communicate with peripheral devices (e.g., Bluetooth speakers, microphones, headsets, etc.). Moreover, communication interface(s) 403 may be coupled to chipset 402 via a Peripheral Component Interconnect Express (PCIe) bus, or the like.

Chipset 402 may be coupled to display and/or touchscreen controller(s) 404, which may include one or more Graphics Processor Units (GPUs) on a graphics bus, such as an Accelerated Graphics Port (AGP) or PCIe bus. As shown, display controller(s) 404 provide video or display signals to one or more display device(s) 405. Display device(s) 405 may include Liquid Crystal Display (LCD), Light Emitting Diode (LED), Organic LED (OLED), or other thin film display technologies. Display device(s) 405 may include a plurality of pixels arranged in a matrix, configured to display visual information, such as text, two-dimensional images, video, three-dimensional images, etc. In some cases, display device(s) 405 may be provided as a single continuous display, rather than two discrete displays.

Chipset 402 may provide host processor(s) 401 and/or display controller(s) 404 with access to system memory 406. In various embodiments, system memory 406 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 402 may also provide host processor(s) 401 with access to one or more Universal Serial Bus (USB) ports/controllers 407, to which one or more peripheral devices may be coupled (e.g., integrated or external webcams, microphones, speakers, etc.).

Chipset 402 may further provide host processor(s) 401 with access to a disk controller 408, which may include a disk interface that connects the disc controller 408 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 400. An example of external interface includes a USB interface, an IEEE 1394 (Firewire) interface, a proprietary interface, or a combination thereof.

Chipset 402 may also provide access to one or more user input devices 409, for example, using a super I/O controller or the like. Examples of user input devices 409 include, but are not limited to, a keyboard 409a, pointing device 409b, such as a mouse, trackball, stylus, or active pen, and/or microphone(s) 409c. Other user input devices 409 (not shown) may include a camera, touchpad, totem, etc. Each user input device 409 may include a respective controller (e.g., a touchpad may have its own touchpad controller) that interfaces with chipset 402 through a wired or wireless connection, for example via communication interfaces(s) 403 and/or USB port(s) 407. Other input devices, such as keyboard 409a, may use a keyboard controller in an operating system.

In some cases, chipset 402 may also provide access to one or more output devices, such as an audio subsystem 410, speakers, headsets, video projectors, paper printers, 3D printers, Virtual/Augmented Reality (VR/AR) devices, etc. The output devices may be accessed, for example, via communication interfaces(s) 403 and/or USB port(s) 407. Audio subsystem 410 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 402 may further provide an interface for communications with one or more hardware sensors 411. Sensors 411 may be disposed on or within the chassis of IHS 400, or otherwise coupled to IHS 400, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 412 is coupled to chipset 402. UEFI was designed as a successor to BIOS, and many modern IHSs utilize UEFI in addition to or instead of a BIOS. Accordingly, BIOS/UEFI 412 is intended to also encompass a UEFI component. BIOS/UEFI 412 provides an abstraction layer that allows the OS to interface with certain hardware components that are utilized by IHS 400. Upon booting of IHS 400, host processor(s) 401 may utilize program instructions of BIOS 412 to initialize and test hardware components coupled to IHS 400, and to load a host OS for use by IHS 400. Via the hardware abstraction layer provided by BIOS/UEFI 412, software stored in system memory 406 and executed by host processor(s) 401 can interface with I/O devices coupled to IHS 400.

An Embedded Controller (EC) 413 (sometimes referred to as a Baseboard Management Controller or “BMC”) includes a microcontroller unit or processing core dedicated to handling selected IHS operations not ordinarily handled by host processor(s) 401. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 400, EC 413 may be made operational from the very start of each power reset, before other devices are fully running or powered on. As such, EC 413 may be responsible for interfacing with a power adapter to manage the power consumption of IHS 400. These operations may be utilized to determine the power status of IHS 400, such as whether IHS 400 is operating from battery power or is plugged into an AC power source. Firmware instructions utilized by EC 413 may be used to manage other core operations of IHS 400 (e.g., turbo modes, maximum operating clock frequencies of certain components, etc.).

In some cases, EC 413 may implement operations for detecting certain changes to the physical configuration or posture of IHS 400 and managing other devices in different configurations of IHS 400. For instance, when IHS 400 as a 2-in-1 laptop/tablet form factor, EC 413 may receive inputs from a lid position or hinge angle sensor 411, and it may use those inputs to determine: whether the two sides of IHS 400 have been latched together to a closed position or a tablet position, the magnitude of a hinge or lid angle, etc. In response to these changes, the EC may enable or disable certain features of IHS 400 (e.g., front or rear facing camera, etc.).

In some implementations, EC 413 may be installed as a Trusted Execution Environment (TEE) component to the motherboard of IHS 400. Additionally, or alternatively, EC 413 may be further configured to calculate hashes or signatures that uniquely identify individual components of IHS 400. In such scenarios, EC 413 may calculate a hash value based on the configuration of a hardware and/or software component coupled to IHS 400. For instance, EC 413 may calculate a hash value based on all firmware and other code or settings stored in an onboard memory of a hardware component.

In addition, EC 413 may provide an Out-of-Band communication channel that allows an Information Technology Decision Maker (ITDM) or Original Equipment Manufacturer (OEM) to manage IHS 400's various settings and configurations, for example, by issuing OOB commands.

In various embodiments, IHS 400 may be coupled to an external power source through an AC adapter, power brick, or the like. The AC adapter may be removably coupled to a battery charge controller to provide IHS 400 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 414 may be coupled to EC 413 and it may include, for example, an Analog Front End (AFE), storage (e.g., non-volatile memory), and a microcontroller. In some cases, BMU 414 may be configured to collect and store information, and to provide that information to other IHS components.

Examples of information collectible by BMU 414 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 400 may not include all the components shown in FIG. 4. Furthermore, some components that are represented as separate components in FIG. 4 may instead be integrated with other components, such that all or a portion of the operations executed by the illustrated components may instead be executed by the integrated component. For example, in various embodiments described herein, host processor(s) 401 and/or other components shown in FIG. 4 (e.g., chipset 402, display controller(s) 404, communication interface(s) 403, EC 413, etc.) may be replaced by other devices. As such, IHS 400 may assume different form factors including, but not limited to: servers, workstations, desktops, laptops, appliances, video game consoles, tablet computers, smartphones, etc.

In one embodiment, a device comprises a processor and a memory coupled to the processor. The memory has program instructions stored thereon that, upon execution, cause the processor to establish a secure communication channel to a control plane during a device onboarding process, identify a current onboarding operating system (OOS) version to the control plane, receive a new OOS from the control plane, set a next boot instruction to use the new OOS, and reboot the device using the new OOS. The program instructions further cause the processor to create a temporary partition on a device hard drive, install the new OOS to the temporary partition, and set the new OOS to be used during the reboot. The program instructions further cause the processor to determine that the device rebooted using the new OOS in the temporary partition, replacing the current OOS with the new OSS, adjusting a boot order to use the new OSS, and removing the temporary partition. The program instructions further cause the processor to fail the device onboarding process when the new OOS is received from the control plane.

The onboarding process may use a Fast Identification (ID) Online (FIDO) Device Onboarding (FDO) protocol; and the current OOS version may be identified to the control plane using a TO2.NextDeviceServiceInfo message. The new OOS version may be received from the control plane using a TO2.NextOwnerServiceInfo message.

The program instructions further cause the processor to identify a current firmware version to the control plane, receive new firmware from the control plane, and install the new firmware before rebooting the device using the new OOS.

In an example arrangement, a method comprises preparing an edge computing device to execute a device onboarding protocol, establishing a communication channel between the device and a control plane, identifying a current device onboarding operating system (OOS) to the control plane, determining, by the control plane; whether an updated OOS is available, providing the updated OOS to the device from the control plane, and rebooting the edge computing device to the updated OOS. The method may further comprise creating a temporary partition on a hard drive on the edge computing device, installing the updated OOS to the temporary partition, and setting the edge computing device to boot using the updated OOS on a next boot. The method may further comprise determining whether the edge computing device has booted from a temporary partition, and if the edge computing device has not booted from a temporary partition, then initiating an onboarding protocol.

The method may comprise determining whether the edge computing device has booted from a temporary partition, and if the edge computing device has booted from a temporary partition, then replacing the current OOS with the updated OOS, and removing the temporary partition.

The method may further comprise failing the device onboarding protocol when the updated OOS is received from the control plane.

The method may further comprise identifying a current firmware version on the edge computing device to the control plane, receiving new firmware at the edge computing device from the control plane, and installing the new firmware on the edge computing device before rebooting using the new OOS.

In an example embodiment, a non-transitory computer-readable medium or media comprises one or more sequences of instructions that, when executed by at least one processor of a device, cause steps for upgrading an onboarding operating system (OOS) on a device. The steps comprising initiating a device onboarding protocol between the device and a control plane, identifying a current device OOS to the control plane, receiving an updated device OOS from the control plane, creating a temporary partition on a hard drive on the device, installing the updated device OOS to the temporary partition, setting the device to boot using the updated device OOS on a next boot, and rebooting the device to the updated device OOS.

The steps may further comprise determining that the device has booted from a temporary partition, replacing the current device OOS with the updated device OOS, removing the temporary partition, and reinitiating the device onboarding protocol.

The steps may further comprise failing the device onboarding protocol when the updated device OOS is received from the control plane.

The current device OOS may be identified to the control plane using a TO2.NextDeviceServiceInfo message, and the new device OOS may be provided by the control plane using a TO2.NextOwnerServiceInfo message.

The steps may further comprise identifying a current firmware version on the edge computing device to the control plane, receiving new firmware at the edge computing device from the control plane, and installing the new firmware on the edge computing device before rebooting using the updated device OOS.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A device, comprising:
a processor; and
a memory coupled to the processor, the memory having program instructions stored thereon that, upon execution, cause the processor to:
establish a secure communication channel to a control plane during a device onboarding process;
identify a current onboarding operating system (OOS) version to the control plane;
receive a new OOS from the control plane;
set a next boot instruction to use the new OOS; and
reboot the device using the new OOS.

2. The device of claim 1, wherein the program instructions further cause the processor to:
create a temporary partition on a device hard drive;
install the new OOS to the temporary partition; and
set the new OOS to be used during the reboot.

3. The device of claim 2, wherein the program instructions further cause the processor to:
determine that the device rebooted using the new OOS in the temporary partition;
replacing the current OOS with the new OSS;
adjusting a boot order to use the new OSS; and
removing the temporary partition.

4. The device of claim 1, wherein the program instructions further cause the processor to:
fail the device onboarding process when the new OOS is received from the control plane.

5. The device of claim 1, wherein the onboarding process uses a Fast Identification (ID) Online (FIDO) Device Onboarding (FDO) protocol; and wherein the current OOS version is identified to the control plane using a TO2.NextDeviceServiceInfo message.

6. The device of claim 1, wherein the onboarding process uses a Fast Identification (ID) Online (FIDO) Device Onboarding (FDO) protocol; and wherein the new OOS version is received from the control plane using a TO2.NextOwnerServiceInfo message.

7. The device of claim 1, wherein the program instructions further cause the processor to:
identify a current firmware version to the control plane;
receive new firmware from the control plane; and
install the new firmware before rebooting the device using the new OOS.

8. A method, comprising:
preparing an edge computing device to execute a device onboarding protocol;
establishing a communication channel between the device and a control plane;
identifying a current device onboarding operating system (OOS) to the control plane;
determining, by the control plane; whether an updated OOS is available;
providing the updated OOS to the device from the control plane; and
rebooting the edge computing device to the updated OOS.

9. The method of claim 8, further comprising:
creating a temporary partition on a hard drive on the edge computing device;
installing the updated OOS to the temporary partition; and
setting the edge computing device to boot using the updated OOS on a next boot.

10. The method of claim 9, further comprising:
determining whether the edge computing device has booted from a temporary partition; and
if the edge computing device has not booted from a temporary partition, then initiating an onboarding protocol.

11. The method of claim 9, further comprising:
determining whether the edge computing device has booted from a temporary partition; and
if the edge computing device has booted from a temporary partition, then replacing the current OOS with the updated OOS; and
removing the temporary partition. The method of claim 8, further comprising:
failing the device onboarding protocol when the updated OOS is received from the control plane.

13. The method of claim 8, wherein the onboarding protocol is a Fast Identification (ID) Online (FIDO) Device Onboarding (FDO) protocol; and wherein the current OOS is identified to the control plane using a TO2.NextDeviceServiceInfo message.

14. The method of claim 8, wherein the onboarding protocol is a Fast Identification (ID) Online (FIDO) Device Onboarding (FDO) protocol; and wherein the new OOS is provided by the control plane using a TO2.NextOwnerServiceInfo message.

15. The method of claim 8, further comprising:
identifying a current firmware version on the edge computing device to the control plane;
receiving new firmware at the edge computing device from the control plane; and
installing the new firmware on the edge computing device before rebooting using the new OOS.

16. A non-transitory computer-readable medium or media comprising one or more sequences of instructions that, when executed by at least one processor of a device, cause steps for upgrading an onboarding operating system (OOS) on a device comprising:
initiating a device onboarding protocol between the device and a control plane;
identifying a current device OOS to the control plane;
receiving an updated device OOS from the control plane;
creating a temporary partition on a hard drive on the device;
installing the updated device OOS to the temporary partition;
setting the device to boot using the updated device OOS on a next boot; and
rebooting the device to the updated device OOS.

17. The non-transitory computer-readable medium or media of claim 16, further comprising one or more sequences of instructions that, when executed by the at least one processor, cause steps to be performed comprising:
determining that the device has booted from a temporary partition;
replacing the current device OOS with the updated device OOS;
removing the temporary partition; and
reinitiating the device onboarding protocol.

18. The non-transitory computer-readable medium or media of claim 16, further comprising one or more sequences of instructions that, when executed by the at least one processor, cause steps to be performed comprising:
failing the device onboarding protocol when the updated device OOS is received from the control plane.

19. The non-transitory computer-readable medium or media of claim 16, wherein the onboarding protocol is a Fast Identification (ID) Online (FIDO) Device Onboarding (FDO) protocol;
wherein the current device OOS is identified to the control plane using a TO2.NextDeviceServiceInfo message; and
wherein the new device OOS is provided by the control plane using a TO2.NextOwnerServiceInfo message.

20. The non-transitory computer-readable medium or media of claim 16, further comprising one or more sequences of instructions that, when executed by the at least one processor, cause steps to be performed comprising:
identifying a current firmware version on the edge computing device to the control plane;
receiving new firmware at the edge computing device from the control plane; and
installing the new firmware on the edge computing device before rebooting using the updated device OOS.
